(19) United States
(12) Patent Application Publication
(10) Pub. No.: US 2008/0228775 A1
(43) Pub. Date: Sep. 18, 2008

(54) Youth communities in a geo-spatial environment

(75) Inventors: Raj Vasant Abhyanker, Cupertino, CA (US); William H. Harris, Woodside, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/724,761

(22) Filed: Mar. 15, 2007

(51) Int. Cl. G06F 21/00

(52) U.S. Cl. 707/10

(57) ABSTRACT

A method, apparatus and system of youth communities in a geo-spatial environment are disclosed. In one embodiment, a method includes generating a set of user profiles above a general mapping environment, determining that one of the set of user profiles in a guardian profile through a verification technique, creating a dependent profile in a youth mapping environment when a guardian user associated with the guardian profile elects to allow a dependent user to create the dependent profile in the youth mapping environment, restricting access of the dependent user in the youth mapping environment based on a set of permissions granted by the guardian user and simultaneously visualizing the dependent profile based on a location data associated with the dependent profile along with adjacent dependent profiles having adjacent location data to the location data.

### FIELD OF TECHNOLOGY

This disclosure relates generally to the technical fields of communications and, in one example embodiment, to a method, apparatus, and system of youth communities in a geo spatial environment.

### BACKGROUND

Youth (e.g., children, dependents, young adults, college students, etc.) may form relationships with other youth through a social network (e.g., MySpace®, Friendster®, etc.). A guardian (e.g., a parent) of the youth may want to ensure that his/her children are safe in the social network. The social network may have a privacy policy that encourages youth to get permission from the guardian prior to using the social network. However, compliance with such privacy policies can be difficult to enforce.

The social network may have profiles of users who are not in their youth (e.g., adults). These profiles may be accessible by the youth. In addition, the youth may communicate and share ideas with users who are not in their youth through the social network, to a dismay of the guardian. The guardian may not want the youth to participate in the social network because they may not want to expose identity of the youth to users who are not in their youth. As a result, the youth may not benefit from the rich emotional, social, and educational benefits of interacting with other youth through the social network.

### SUMMARY

A method, apparatus and system of youth communities in a geo spatial environment are disclosed. In one aspect, a method includes generating a set of user profiles above a general mapping environment, determining that one of the set of user profiles is a guardian profile through a verification technique, creating a dependent profile in a youth (e.g., the youth are under eighteen-years of age) mapping environment when a guardian user associated with the guardian profile elects to allow a dependent user to create the dependent profile in the youth mapping environment (e.g., the youth mapping environment may not have profiles found in the general mapping environment and is restricted to including profiles of youth), restricting access of the dependent user in the youth mapping environment based on a set of permissions granted by the guardian user, and simultaneously visualizing the dependent profile based on a location data associated with the dependent profile along with adjacent dependent profiles having adjacent location data to the location data.

In addition, the method may include providing access of the dependent user to only other profiles in the youth mapping environment that may correspond to an age group of the dependent user. The method may further include geo-fencing search criteria of the dependent users in the youth mapping environment when the guardian user associated with the guardian profile elects a geographic region acceptable of search by the dependent user. The method may also include decorating the dependent profile when the dependent user may select a color scheme, an avatar style, a wallpaper, a furniture, a garden, and/or accessories to express the dependent profile in the youth mapping environment. The method may further include exchanging communications with other users of the youth mapping environment based on a set of permissions afforded by the guardian user in the general mapping environment.

The method may also include monitoring communications, activities, friends, and/or experiences of the dependent user in the youth mapping environment through an information module that provides aggregate experience data to the guardian user of activity of the dependent user in the youth mapping environment. In addition, the method may include creating friendship, education, and/or social groups between the dependent user and other dependent users in the youth mapping environment.

Furthermore, the method may include providing a learning interface to the dependent user in the youth mapping environment when the guardian user and the dependent user elect one of an approved teaching mentor in the youth mapping environment, exchanging between the dependent user and other dependent users in the youth mapping environment collectibles, trading cards, toys, and/or activities based on a currency utilizable in the youth mapping environment, and/or qualifying teaching mentors in the youth mapping environment through a voting of other guardian users in the general mapping environment.

The method may further include providing tools to the guardian user in the general mapping environment to exchange babysitting, parenting, commuting, volunteering and/or item exchanging opportunities with other guardian users of the general mapping environment. Moreover, the method may include enabling the guardian user to form a trust circle with other guardian users of the general mapping environment so as to enable the youth users associated with the guardian users to freely communicate and/or exchange items with other users associated with guardians in the trust circle. The method may further include organizing, through the trust circle, activities, recreational sports, music groups, dance groups, classes, tutoring sessions, and/or sports leagues in the youth mapping environment, and/or scheduling a reservation in a community location in a neighborhood through the general mapping environment and/or the youth mapping environment.

The method may also include transforming the general mapping environment and the youth mapping environment to a wiki environment in which users may create and/or add content to profiles of others through a wiki interface until the profiles are claimed by a claimant, and simultaneously visualizing in the general mapping environment and the youth mapping environment profiles of neighboring addresses through a three-dimensional perspective view of a neighborhood.

In another aspect, a system includes a network, a youth mapping environment to generate profiles of minors in a neighborhood and to include only minors who have been verified as permitted as participants in the youth mapping environment, a general mapping environment coupled to the youth mapping environment to enable parents to create access privileges of their minor children in the youth mapping environment, and a central module to enable the parents to form sharing groups with other parents in the general mapping environment and to provide an interface such that the parents can monitor activities of their children in the youth mapping environment and to segregate users of the youth mapping environment from users of the general mapping environment.

Furthermore, the system may include a security module of the central module to ensure that identity of the parents may be verified prior to the parents creating access privileges of their minor children in the youth mapping environment. The system may also include an activity module of the central module to arrange and reserve parks, halls, and/or restaurants for sharing groups in the general mapping environment and to automatically send invites to dependent users in the youth mapping environment when an arranged activity may involve scheduling of children's recreational, educational, and/or social activities.

In yet another aspect, a method includes creating a dependent social network having a set of users who have been verified to be dependents of guardian users of a parent social network, and in which user profiles in the parent social network are not visible to users of the dependent social network, and in which profiles of the dependent social network are not visible to users of the parent social network except for a particular guardian user overseeing a particular dependent user, forming groups among the set of users such that the particular dependent user is a member of a particular group after being approved by the particular guardian user in the parent social network, restricting access to certain users in the dependent social network by the particular dependent user based on a preference of the particular guardian user, and generating neighboring ones of the particular dependent users of the dependent social network such that users of the dependent social network are able to visualize neighbors living in close proximity and are able to exchange communications between them through a postal mail communication and an electronic communication.

The method may further include forming affinity groups between users of the dependent social network such that users of the dependent social network, barter, communicate and learn between each other.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a central module communicating with a general mapping environment and a youth mapping environment through a network, according to one embodiment.

FIG. 2 is an exploded view of the activity module of FIG. 1, according to one embodiment.

FIG. 3 is an exploded view of the group module of FIG. 1, according to one embodiment.

FIG. 4 is a user interface view of a search methodology of other dependent users in the youth mapping environment, according to one embodiment.

FIG. 5 is a user interface view of a social networking and a blogging destination, according to one embodiment.

FIG. 6 is a user interface view of a children's group available for dependent users in the youth mapping environment, according to one embodiment.

FIG. 7 is a user interface view of a children's blog, according to one embodiment.

FIG. 8 is a diagrammatic system view of a data processing system in which any of the embodiments disclosed herein may be performed, according to one embodiment.

FIG. 9 is a user interface view of a children's album, according to one embodiment.

FIG. 10 is a table view displaying information on the dependent users in the youth mapping environment 128, according to one embodiment.

FIG. 11 is a user interface view of a guardian user profile, according to one embodiment.

FIG. 12A is a process flow of creating a dependent profile in a youth mapping environment, according to one embodiment.

FIG. 12B is a continuation of the process flow of FIG. 12A illustrating additional processes, according to one embodiment.

FIG. 12C is a continuation of the process flow of FIG. 12B illustrating additional processes, according to one embodiment.

FIG. 13 is a process flow of restricting access to certain users in a dependent social network, according to one embodiment.

Other features of the present embodiments will be apparent from the accompanying drawings and from the detailed description that follows.

### DETAILED DESCRIPTION

A method, apparatus and system of youth communities in a geo spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

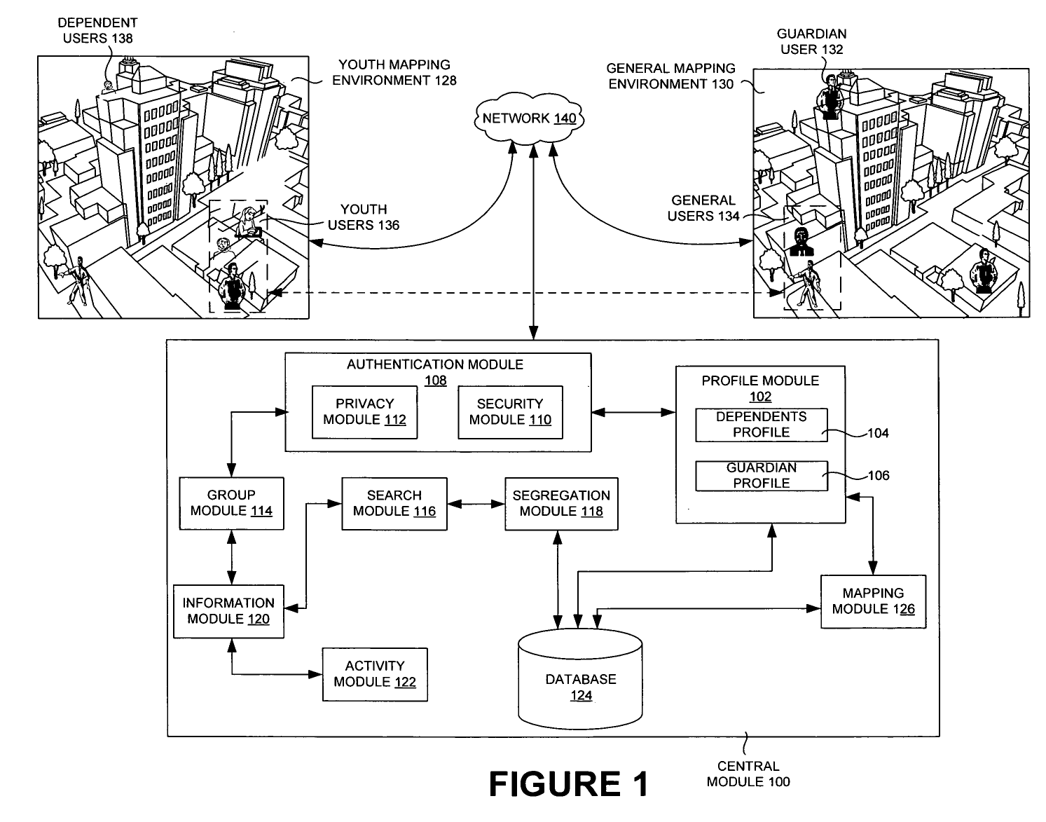

In one embodiment, a method includes generating a set of user profiles above a general mapping environment (e.g., the general mapping environment 130 of FIG. 1), determining that one of the set of user profiles is a guardian profile through a verification technique, creating a dependent profile in a youth mapping environment (e.g., the youth mapping environment 128 of FIG. 1) when a guardian user associated with the guardian profile elects to allow a dependent user (e.g., the dependent user 138 of FIG. 1) to create the dependent profile in the youth mapping environment, restricting access of the dependent user in the youth mapping environment based on a set of permissions granted by the guardian user, and simultaneously visualizing the dependent profile based on a location data associated with the dependent profile along with adjacent dependent profiles having adjacent location data to the location data.

In another embodiment, a system includes a network (e.g., the network 140 of FIG. 1), a youth mapping environment to generate profiles of minors in a neighborhood and to include only minors who have been verified as permitted as participants in the youth mapping environment, a general mapping environment 130 coupled to the youth mapping environment (e.g., the youth mapping environment 128 of FIG. 1) to enable parents create access privileges of their minor children in the youth mapping environment, and a central module (e.g., the central module 100 of FIG. 1) to enable the parents form sharing groups with other parents in the general mapping environment, and/or to provide an interface such that the parents can monitor activities of their children in the youth mapping environment and to segregate users of the youth mapping environment from users of the general mapping environment.

In yet another embodiment, a method includes creating a dependent social network having a set of users who have been verified to be dependents of guardian users of a parent social network (e.g., the dependent users 138 illustrated in FIG. 1), and in which user profiles in the parent social network are not visible to users of the dependent social network, and in which profile of the dependent social network are not visible to users of the parent social network except for a particular guardian user overseeing a particular dependent user (e.g., the guardian user 132 illustrated in FIG. 1), forming groups among the set of users such that the particular dependent user is a member of a particular group after being approved by the particular guardian user in the parent social network, restricting access to certain users in the dependent social network by the particular dependent user based on a preference of the particular guardian user, and generating neighboring ones of the particular dependent users of the dependent social network (e.g., using the central module 100 illustrated in FIG. 1) such that users of the dependent social network are able to visualize neighbors living in close proximity and are able to exchange communications between them through a postal mail communication and an electronic communication.

FIG. 1 is a system view of a central module 100 communicating with a general mapping environment 130 and a youth mapping environment 128 through a network 140, according to one embodiment. Particularly, FIG. 1 illustrates the central module 100, a profile module 102, a dependents profile 104, a guardian profile 106, an authentication module 108, a security module 110, a privacy module 112, a group module 114, a search module 116, a segregation module 118, an information module 120, an activity module 122, a database 124, a mapping module 126, the youth mapping environment 128, the general mapping environment 130, a guardian user 132, a general users 134, a youth users 136, a dependent user 138 and the network 140, according to one embodiment.

The central module 100 may enable the parents to form sharing group with other parents in the general mapping environment 130 and/or may provide an interface such that the parents can monitor activities of their children in the youth mapping environment 128 and/or to segregate users of the youth mapping environment 128 from the users of the general mapping environment 130. The profile module 102 may generate a set of user profiles of both the youth mapping environment 128 and the general mapping environment 130. The dependents profile 104 may create the profile of youth users 136 (e.g., under eighteen-years of age) in the youth mapping environment when the guardian user 132 associated with the guardian profile elects to allow the dependent user 138 to create the dependent profile in the youth mapping environment 128.

The guardian profile 106 may elect, grant a set of permissions and/or restrict access to the dependent user 138 to create the dependent profile in the youth mapping environment 128. The authentication module 108 may verify the identity of the set of users who have been verified to be dependents of guardian users (e.g., through a verification technique). The security module 110 may ensure that the identity of parents is verified prior to the parents creating access privileges of their minor children in the youth mapping environment 128. The privacy module 112 may provide (e.g., generate, process, etc.) permissions to the children from a parent or a guardian to create groups in the youth mapping environment 128.

The group module 114 may create associations between the set of users such that a particular dependent user may be a member of the particular group after being approved by the particular guardian user in the parent social network. The search module 116 may enable geo-fencing when the guardian user 132 is associated with the guardian profile. The segregation module 118 may separate (e.g., segregate) users of the youth mapping environment 128 from the users of the general mapping environment 130. The information module 120 may provide aggregate experience data to the guardian user regarding activity of the dependent user 138 in the youth mapping environment 128.

The activity module 122 may arrange and/or reserve facilities (e.g., parks, halls, and/or restaurants) for sharing groups in the general mapping environment 130 and/or automatically send invites to dependent users in the youth mapping environment 128 when an arranged activity involves scheduling of children's recreational, educational, and/or social activities. The database 124 may hold records and/or information of guardian profiles and/or dependent profiles (e.g., location data, personal data, etc.) in the mapping environment. The mapping module 126 may include maps and graphically visualize (e.g., in a map) physical locations of the users in the youth mapping environment 128 and general mapping environment 130.

The youth mapping environment 128 may generate profiles of minors in a neighborhood and/or minors who have been verified and/or permitted as participants. The general mapping environment 130 may be coupled to the youth mapping environment to enable parents (e.g., the guardian users 132) to create access privileges of their minor(s) (e.g., the dependent users 138). The guardian user 132 may be the parents of the dependent users 138 who can elect, grant a set of permissions and/or restrict access to the dependent user 138. The general users 134 may be the users in the general mapping environment 130. The youth users 136 may be the youth (e.g., under eighteen-years of age) in the youth mapping environment 128.

The dependent users 138 may be minors who have been verified and/or granted permissions from the guardian users 132 to create the dependent profiles in the youth mapping environment 128. The network 140 may facilitate communication between the central module 100, the general mapping environment 130 and/or the youth mapping environment 128 for storing and/or retrieving the information and/or volume of data.

In the example embodiment illustrated in FIG. 1, the central module 100 communicates with the general mapping environment 130 and the youth mapping environment 128 through the network. The central module 100 may consist of the profile module 102, the authentication module 108, the security module 110, the privacy module 112, the group module 114, the search module 116, the segregation module 118, the information module 120, the activity module 122, the database 124, and the mapping module 126 communicating with each other, according to the example embodiment illustrated in FIG. 1.

A set of user profiles may be generated above the general mapping environment (e.g., the general mapping environment 130 of FIG. 1), and/or one of the set of user profiles may be determined as the guardian profile (e.g., through a verification technique). In addition, the a dependent profile may be created in the youth mapping environment (e.g., the youth mapping environment may not have profiles found in the general mapping environment 130 and may be restricted to including profiles of youth who are under eighteen years of age) when the guardian user (e.g., the guardian user 132 of FIG. 1) associated with the guardian profile may elect to allow the dependent user to create the dependent profile in the youth mapping environment.

Furthermore, the access of the dependent user 138 may be restricted in the youth mapping environment (e.g., the youth mapping environment 128 of FIG. 1) based on the set of permissions granted by the guardian user 132. Also, the dependent profile (e.g., based on the location data associated with the dependent profile) may be visualized simultaneously along with adjacent dependent profiles, having adjacent location data to the location data. Further, the access of the dependent user 138 may be provided to only other profiles in the youth mapping environment 128 that correspond to an age group of the dependent user (e.g., the dependent user 138 of FIG. 1).

The search criteria of the dependent users 138 in the youth mapping environment 128 may be geo-fenced when the guardian user 132 associated with the guardian profile elects a geographic region acceptable of search by the dependent user 138. Additionally, the information module (e.g., the information module 120 of FIG. 1) may provide aggregate experience data to the guardian user 132 of activity of the dependent user 138 by monitoring communications, activities, friends, and/or experiences of the dependent user 138 in the youth mapping environment 128. Moreover, the general mapping environment 130 and/or the youth mapping environment 128 may be transformed to a wiki environment in which users can create and/or add content to profiles of others through a wiki interface until the profiles are claimed by a claimant.

The general mapping environment 130 and/or the youth mapping environment 128 profiles of neighboring addresses may be visualized simultaneously through a three-dimensional perspective view of a neighborhood. In addition, the general mapping environment 130 coupled to the youth mapping environment 128 may enable parents to create access privileges of their minor children in the youth mapping environment 128 and/or the central module (e.g., the central module 100 of FIG. 1) to enable the parents to form sharing groups with other parents in the general mapping environment 130 and/or to provide the interface such that the parents can monitor activities of their children in the youth mapping environment 128 and/or to segregate users of the youth mapping environment 128 from users of the general mapping environment 130.

The youth mapping environment 128 may generate profiles of minors in the neighborhood and/or may include only minors who have been verified as permitted as participants in the youth mapping environment 128. In addition, the security module (e.g., the security module 110 of FIG. 1) of the central module 100 may ensure that identity of the parents is verified prior to the parents creating access privileges of their minor children in the youth mapping environment 128. Furthermore, the activity module (e.g., the activity module 122 of FIG. 1) of the central module 100 may arrange and reserve parks, halls, and/or restaurants for sharing groups in the general mapping environment 130 and/or to automatically send invites to dependent users 138 in the youth mapping environment 128when an arranged activity involves scheduling of children's recreational, educational, and/or social activities.

Furthermore, the neighboring ones of the particular dependent users 138 of the dependent social network may be generated such that users of the dependent social network are able to visualize neighbors living in close proximity and are able to exchange communications between them through the postal mail communication and/or an electronic communication.

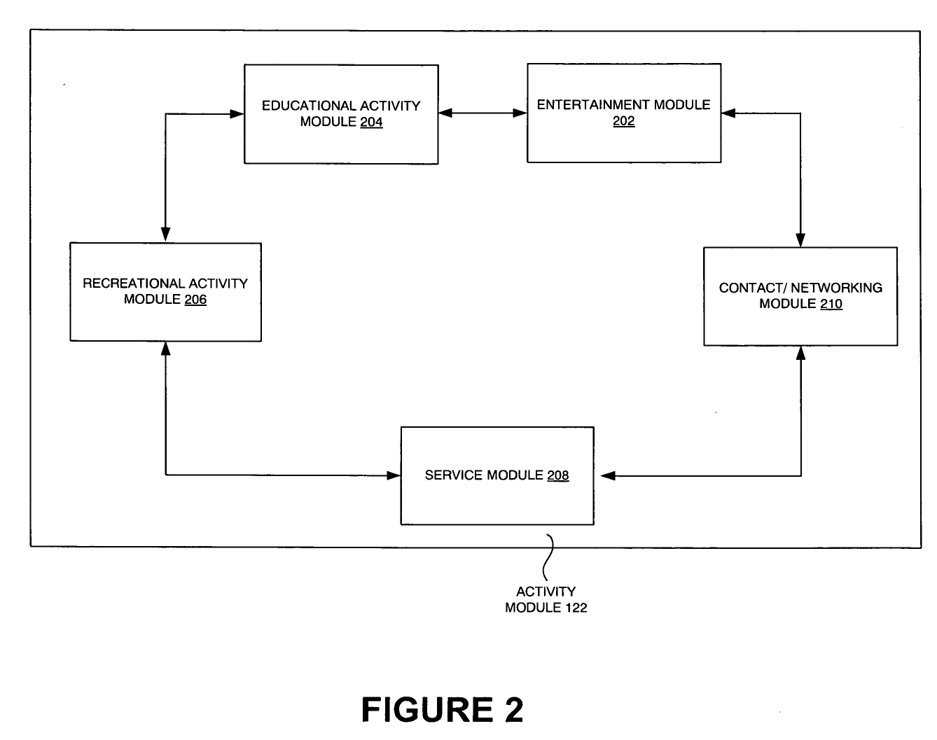

FIG. 2 is an exploded view of the activity module 122 of FIG. 1, according to one embodiment. Particularly, FIG. 2 illustrates an entertainment module 202, an educational activity module 204, a recreational activity module 206, a service module 208 and a contact/networking module 210, according to one embodiment.

The entertainment module 202 may enable the dependent users 138 in the youth mapping environment 128 to actively involve in various activities (e.g., like creating friends, social network, recreation sports, music groups, dance groups, tutoring sessions, sports leagues etc.). The educational activity module 204 may provide a learning interface to the dependent user 138, where the dependent user 138 and/or the guardian users 132 may be given the opportunity to elect the teaching mentors in the youth mapping environment 128.

The recreational activity module 206 may enable the dependent user 132 to organize the activities, recreational sports, music groups, dance groups, classes, tutoring sessions, and sports leagues in the youth mapping environment 128. The service module 208 may provide services like tutors (e.g., educational and homework activities) in the youth mapping environment 128. The contact/networking module 210 may enable the dependent user 138 of the dependent social network to barter, communicate and learn between each other.

In the example embodiment illustrated in FIG. 2, the entertainment module 202 communicates with the educational activity module 204 and the contact/networking module 210. The recreational activity module 206 communicates with the educational activity module 204 and the service module 208. The service module communicates with the contact/networking module 210, according to the example embodiment of FIG. 2.

In one embodiment, a dependent profile (e.g., associated with a dependent user 138) may be decorated when the dependent user 138 selects a color scheme, an avatar style, a wallpaper, a furniture, a garden, and/or accessories to express the dependent profile in the youth mapping environment 128. Also, the users of the youth mapping environment 128 may exchange communications with other users based on the set of permissions afforded by the guardian user 132 in the general mapping environment 130. In addition, the dependent user 138 may create friendship, education, and/or social groups with other dependent users 138 in the youth mapping environment 128.

Also, the dependent user 138 in the youth mapping environment 128 may provide the learning interface when the guardian user 132 and the dependent user 138 elect one of the approved teaching mentor in the youth mapping environment 128. Additionally, the teaching mentors in the youth mapping environment 128 may be qualified through a voting of other guardian users 132 in the general mapping environment 130. Furthermore, the dependent user 138 and/or other dependent users in the youth mapping environment 128 may exchange collectibles, trading cards, toys, and/or activities based on a currency utilizable in the youth mapping environment 128.

In addition, the guardian user 132 in the general mapping environment 130 may provide tools to exchange babysitting, parenting, commuting, volunteering and/or item exchanging opportunities with other guardian users 132 of the general mapping environment 130. Also, the guardian user 132 may be enabled to form a trust circle with other guardian users 132 of the general mapping environment 130 so as to enable the youth users 136 associated with the guardian users 132 to freely communicate and exchange items with other users associated with guardians in the trust circle. Additionally, the activities, recreational sports, music groups, dance groups, classes, tutoring sessions, and/or sports leagues in the youth mapping environment 128 may be organized through the trust circle. The general mapping environment 130 and/or the youth mapping environment 128 may also schedule a reservation in a community location in the neighborhood.

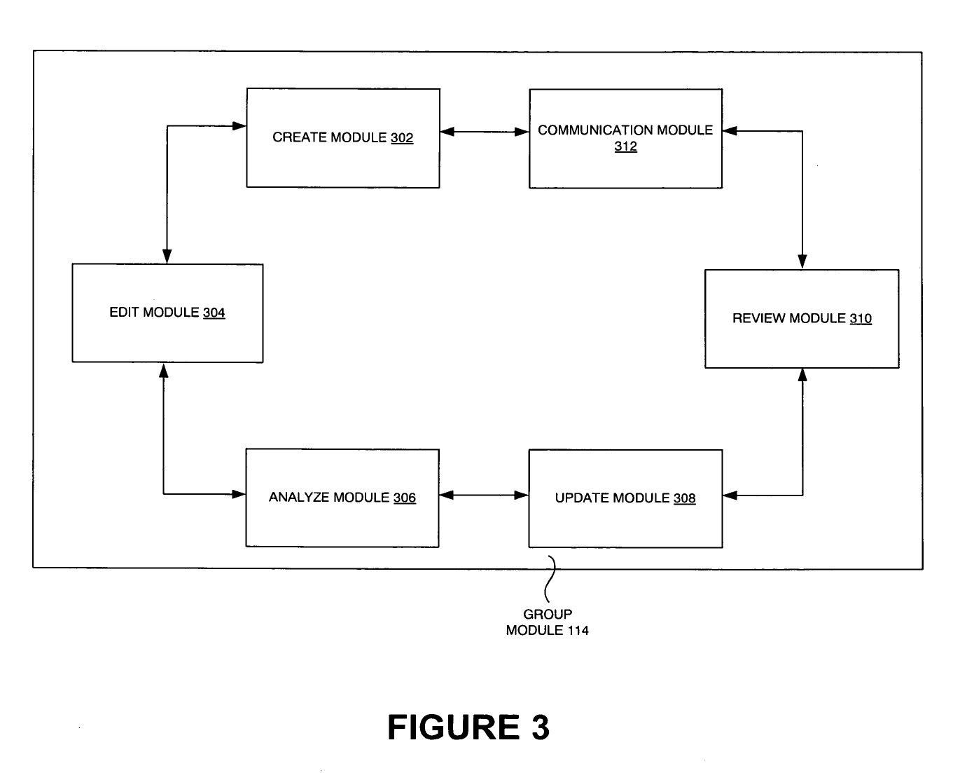

FIG. 3 is an exploded view of the group module 114 of FIG. 1, according to one embodiment. Particularly, FIG. 3 illustrates a create module 302, an edit module 304, a analyze module 306, an update module 308, a review module 310 and a communication module 312, according to one embodiment.

The create module 302 may enable the dependent user (e.g., the dependent user 138 of FIG. 1) to add a data and/or information to the dependent profile associated with the dependent user 138 in the youth mapping environment 128, when a guardian user 132 associated with the guardian profile provides an access. The edit module 304 may allow the dependent user 138 to add, modify and/or update profile details of the groups of the dependent users 138 in the youth mapping environment 128. The analyze module 306 may examine carefully the details about the user profiles of the groups present in the youth mapping environment 128.

The update module 308 may enable the dependent user to update (e.g., by adding and/or deleting) the information of the user profile of the groups in the youth mapping environment 128. The review module 310 may allow the dependent user 138 to evaluate the user profiles of the youth mapping environment 128. The communication module 312 may allow the users to exchange communication with other users of the youth mapping environment 128 based on a set of permissions afforded by the guardian user 132 in the general mapping environment 130.

In example embodiment illustrated in FIG. 3, the create module 302 communicates the edit module 304 and the communication module 312. The analyze module 306 communicates with the edit module 304 and the update module 308. The review module 310 communicates with the update module 308 and the communication module 312, according to the example embodiment illustrated in FIG. 3.

Furthermore, the set of users may form groups such that a particular dependent user is a member of a particular group after being approved by a particular guardian user in the parent social network. Furthermore, the users may form affinity groups of the dependent social network such that users of the dependent social network barter, communicate and/or learn between each other.

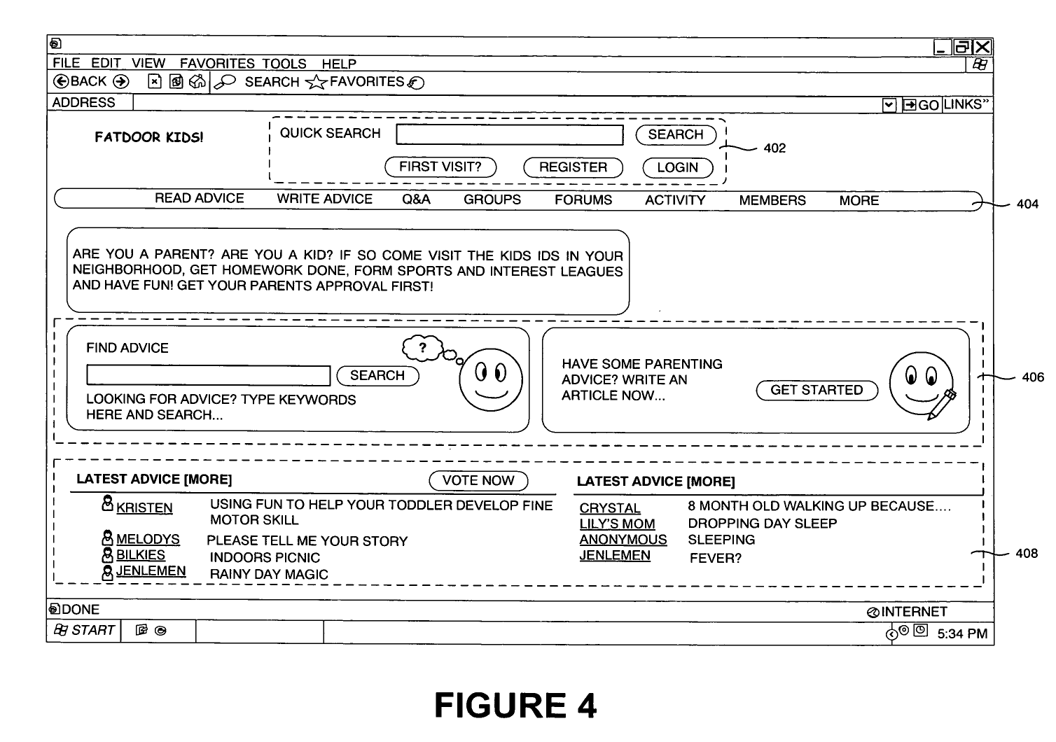

FIG. 4 is a user interface view of a search methodology of other dependent users 138 in the youth mapping environment 128, according to one embodiment. Particularly, FIG. 4 illustrates an option 402, an option 404, an option 406 and an option 408, according to one embodiment. The option 402 may enable the users to search for keywords and/or allow them to register or log into their profiles in the general mapping environment 130. The option 404 may provide tools (e.g., read advice, write advice, Q&A, groups, forums, activity, members, more, etc.) to the user in the youth mapping environment 128.

The option 406 may enable the dependent user 138 to find some advice and/or allow any guardian users 132 to post their opinion, advice and/or thoughts available for the dependent users 138 to view in the youth mapping environment 128. The option 408 may display the latest advice posted by the general users 134 in the general mapping environment 130. In the example embodiment illustrated in FIG. 4, the user interface view may enable the users to quickly search any types of keywords, read advice, view members, etc.

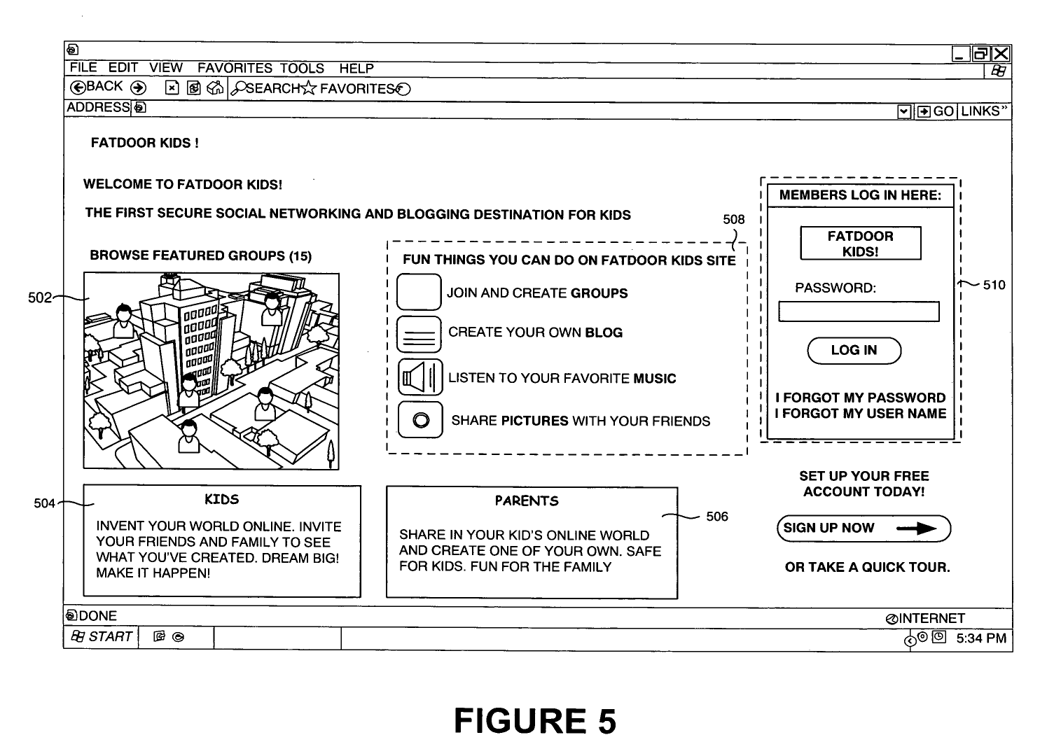

FIG. 5 is a user interface view of a social networking and a blogging destination, according to one embodiment. Particularly, FIG. 5 illustrates a browse featured groups option 502, a kids option 504, a parents option 506, a fun things you can do on Fatdoor kids site option 508 and a members login here option 510, according to one embodiment.

The browse featured groups option 502 may enable the user to search other users and/or their profiles through the various featured groups present in the youth mapping environment 128 (e.g., may display a count of the number of featured groups present). The kids option 504 may allow kids (e.g., young users, dependent users 138, minors, juveniles, etc.) to invent new things and/or may even invite their friends and/or family to join the group to view their innovations. The parents option 506 may be a feature enabled to attract the parents and/or may invite them to share their thoughts in the kids' online world and/or to be a part of their childrens' group.

The fun things you can do on Fatdoor kids site option 508 may allow the kids to join and create groups, create their blogs, listen to their favorite music, and/or share pictures with their friends and/or family. The members log in here option 510 may enable the kids to log in the site and browse.

In the example embodiment illustrated in FIG. 5, the user interface view may enable the user to browse featured groups and/or invent their world(s) online. Also, the user may invite friends and family to see what the user has created in the youth mapping environment 128.

The dependent social network may be created having the set of users who have been verified to be dependents of guardian users 132 of the parent social network, and in which user profiles in the parent social network are not visible to users of the dependent social network, and in which profiles of the dependent social network are not visible to users of the parent social network except for the particular guardian users overseeing the particular dependent users.

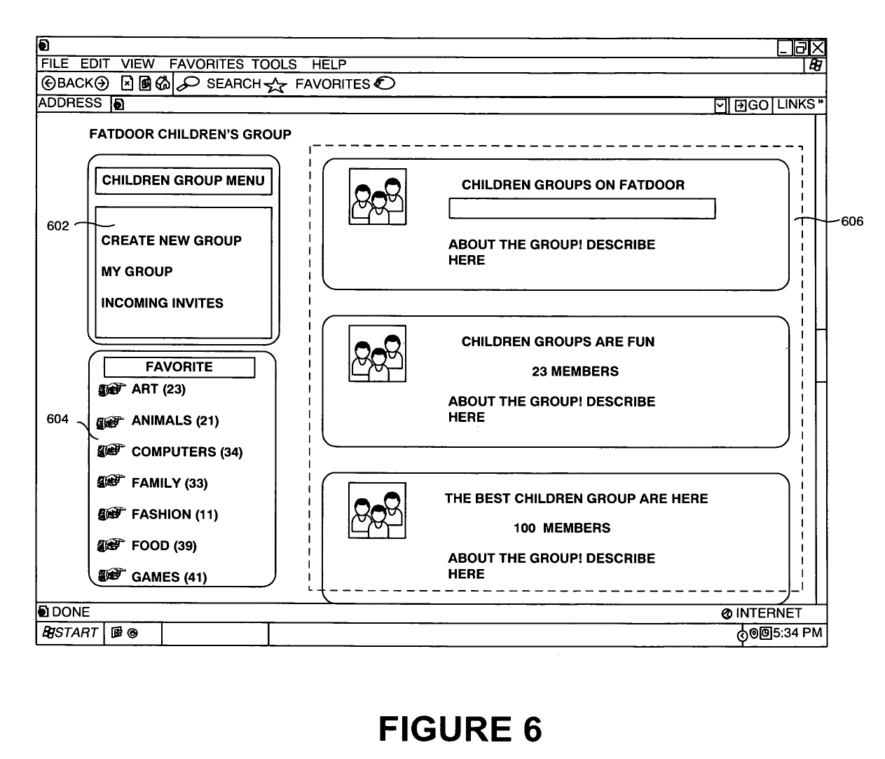

FIG. 6 is a user interface view of a children's group available for dependent users in the youth mapping environment 128, according to one embodiment. Particularly, FIG. 6 illustrates a children group menu option 602, a favorite option 604 and an option 606, according to one embodiment.

The children group menu option 602 may enable the children's to create new group and/or allow the others to view the groups created by them and/or to accept/decline the invitations sent by other users. The favorite option 604 may be a browser tool that facilitates a quick reference for the dependent user 138 to view their favorites (e.g., groups like art, animals, computers, family, fashion, food, games, etc.). The option 606 may enable the users to view the children's groups which may describe the group and/or the members in the group (e.g., the best children group members).

In the example embodiment illustrated in FIG. 6, the user interface view may enable the user to create new groups and/or allow/accept/decline incoming invites. Also, the user interface view may enable the user to view the members in the best children group.

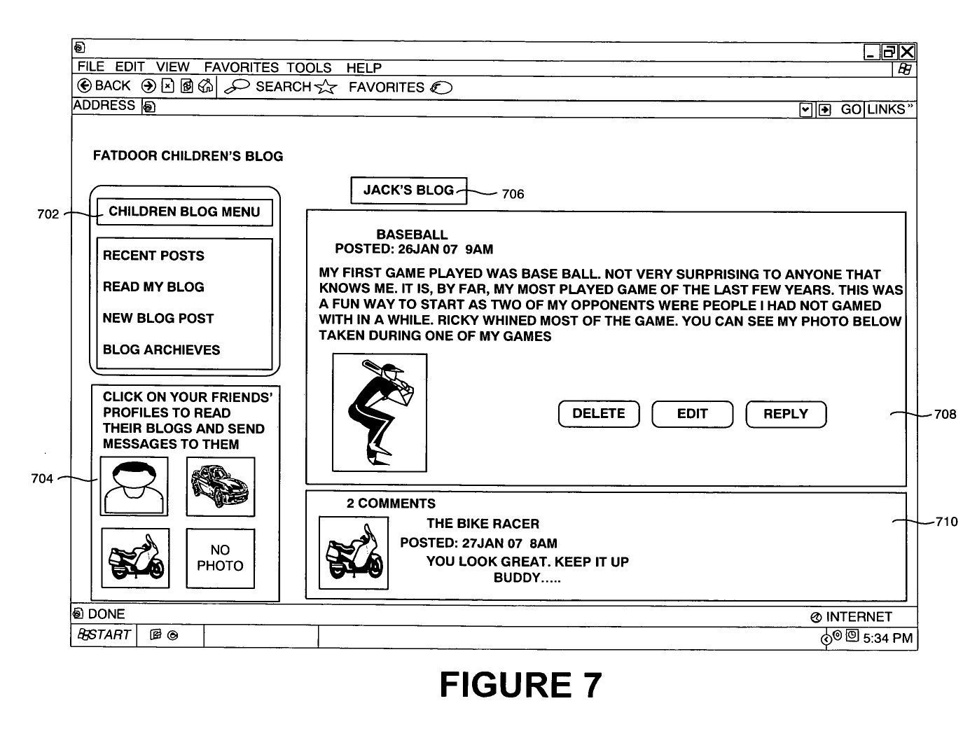

FIG. 7 is a user interface view of a children's blog, according to one embodiment. Particularly, FIG. 7 illustrates a children blog menu option 702, a click on your friends' profiles to read their blogs and send messages to them option 704, a user blog option 706, an option 708 and a comments option 710, according to one embodiment.

The children blog menu option 702 may enable the user to view recent postings, read their blog, new blog postings and/or blog archives of the youth mapping environment 128. The click on your friends' profiles to read their blogs and send messages to them option 704 may enable the dependent users 138 of the youth mapping environment 128 to view their friends' profiles and/or read their blogs, and/or communicate with other dependent users 138 by sending messages in the youth mapping environment 128.

The user blog option 706 may enable the user to view the profile (e.g., “Jack's blog,” a user profile of a dependent user 138, etc.) and related information (e.g., allows the user to read the blogs posted recently). The option 708 may enable the blog owner (e.g., the dependent user 138 approved by the guardian user 132 of FIG. 1) to delete, edit and/or reply to the blogs posted by other users. The comments option 710 may allow other dependent users 138 to write the comments (e.g., you look great, keep it up buddy).

In the example embodiment illustrated in FIG. 7 the user interface view may enable the user to view the recent postings and/or read the blogs. Also, the user interface view may enable the user to click on their friends' profiles to read their blogs and send messages to them.

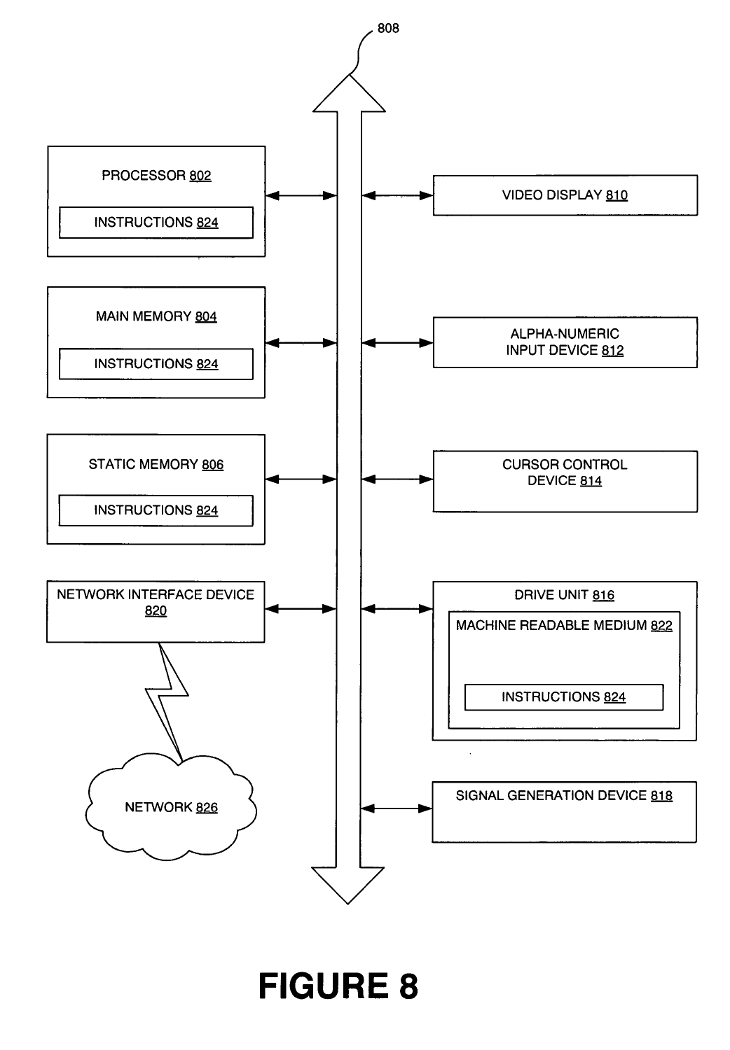

FIG. 8 is a diagrammatic system view 800 of a data processing system in which any of the embodiments disclosed herein may be performed, according to one embodiment. Particularly, the system view 800 of FIG. 8 illustrates a processor 802, a main memory 804, a static memory 806, a bus 808, a video display 810, an alpha-numeric input device 812, a cursor control device 814, a drive unit 816, a signal generation device 818, a network interface device 820, a machine readable medium 822, instructions 824, and a network 826, according to one embodiment.

The diagrammatic system view 800 may indicate a personal computer and/or a data processing system in which one or more operations disclosed herein may be performed. The processor 802 may be microprocessor, a state machine, an application specific integrated circuit, a field programmable gate array, etc. (e.g., Intel® Pentium® processor). The main memory 804 may be a dynamic random access memory and/or a primary memory of a computer system. The static memory 806 may be a hard drive, a flash drive, and/or other memory information associated with the data processing system.

The bus 808 may be an interconnection between various circuits and/or structures of the data processing system. The video display 810 may provide graphical representation of information on the data processing system. The alpha-numeric input device 812 may be a keypad, a keyboard and/or any other input device of text (e.g., a special device to aid the physically handicapped). The cursor control device 814 may be a pointing device such as a mouse.

The drive unit 816 may be a hard drive, a storage system, and/or other longer term storage subsystem. The signal generation device 818 may be a bios and/or a functional operating system of the data processing system. The network interface device 820 may be a device that may perform interface functions such as code conversion, protocol conversion and/or buffering required for communication to and from a network. The machine readable medium 822 may provide instructions on which any of the methods disclosed herein may be performed. The instructions 824 may provide source code and/or data code to the processor 802 to enable any one/or more operations disclosed herein.

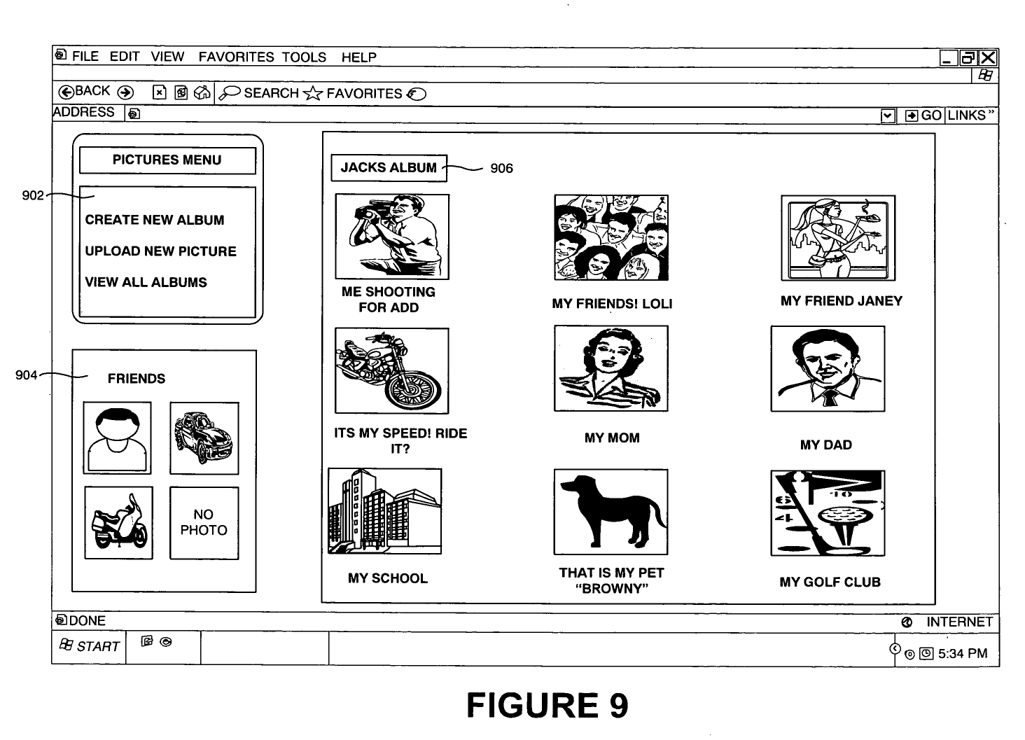

FIG. 9 is a user interface view of a children's album, according to one embodiment. Particularly, FIG. 9 illustrates a pictures menu option 902, a friends option 904, and a user album option 906, according to one embodiment.

The pictures menu option 902 may enable the user to create a new album, upload new pictures and/or allow other users to view all albums in the youth mapping environment 128. The friends option 904 may allow the user and other users to view others children profiles in the youth mapping environment 128. The user album 906 option may enable the user to view and/or share favorite photos with their family and/or friends in the youth mapping environment 128.

In example embodiment of FIG. 9, the user interface view may enable the user to create new albums, upload new pictures and/or view all albums as perceived by the user in the mapping environment.

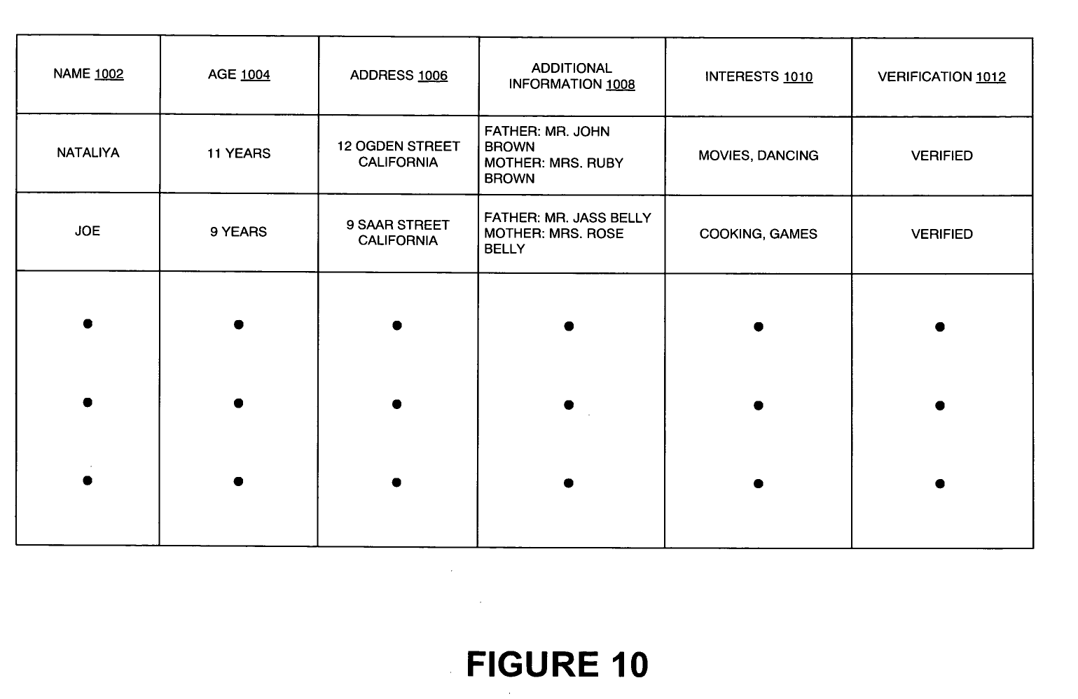

FIG. 10 is a table view 1000 displaying information on the dependent users 138 in the youth mapping environment 128, according to one embodiment. Particularly, FIG. 10 illustrates a name field 1002, an age field 1004, an address field 1006, a additional information field 1008, an interests field 1010 and a verification field 1012, according to one embodiment.

The name field 1002 may display the name of the dependent users 138 in the youth mapping environment 128. The age field 1004 may display the age of the dependent user 138. The address field 1006 may be the information associated with the address data and/or location of the dependent users 138 in the youth mapping environment 128. The additional information field 1008 may display a name of the guardian user 132 associated with the guardian profile in the youth mapping environment 128. The interests field 1010 may display the various activities the dependent user 138 may be involved in. The verification field 1012 may determine the status of the dependent user 138 in the youth mapping environment 128.

In the example embodiment illustrated in FIG. 10, the name field displays “Nataliya” in the first row and “Joe” in the second row of the name field 1002 column. The age field 1004 displays “11 years” in the first row and “9 years” in the second row of the age field 1004 column. The address field 1006 displays “12 Ogden street, California” in the first row and “9 Saar street, California” in the second row of the address field 1006 column. The additional information field 1008 displays “Father: Mr. John Brown, Mother: Mrs. Ruby Brown” in the first row and “Father: Mr. Jass Belly, Mother: Mrs. Rose Belly” in the second row of the additional information field 1008 column. The interests field 1010 displays “movies, dancing” in the first row and “cooking, games” in the second row of the interest field 1010 column. The verification field 1012 displays “verified” in the first row and “verified” in the second row of the verification field 1012 column.

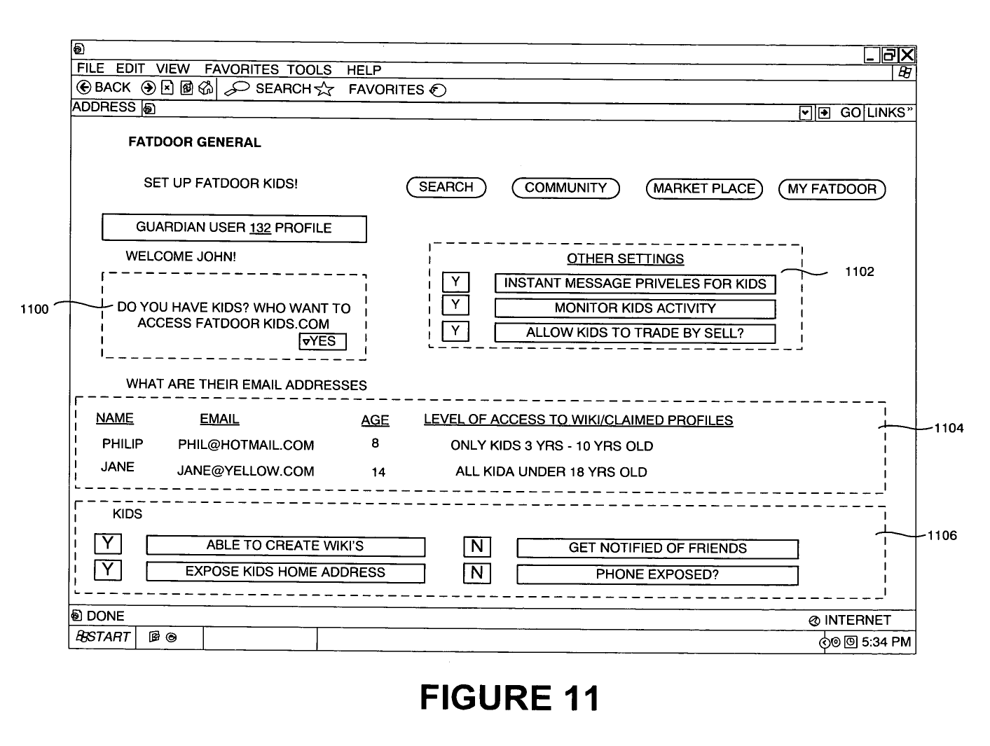

FIG. 11 is a user interface view of a guardian user 132 profile, according to one embodiment. Particularly, FIG. 11 illustrates an option 1100, an option 1102, an option 1104, and an option 1106, according to one embodiment.

The option 1100 may query the guardian user to opt for an option “yes” if he/she has kids (e.g., minors, dependents, children, etc.) who want to access the website. The option 1102 may be a control (e.g., a checkbox) to update the setting (e.g., granting a set of permissions and/or restrict access to the dependent users 138 by the guardian user 132). The option 1104 may display the profile information of the kids and also the level of access to wiki/claimed profile given to the kids by the guardian user 132. The option 1106 may be a control (e.g., checkbox) to update the setting to monitor the kid's activity by the guardian user 132.

In the example embodiment illustrated in FIG. 11, the user interface view may enable the guardian user 132 to monitor the kids' activity and/or allow kids to trade, buy and/or sell in the mapping environment. Furthermore, access to certain users may be restricted in the dependent social network by the particular dependent user 138 based on a preference of the particular guardian user 132.

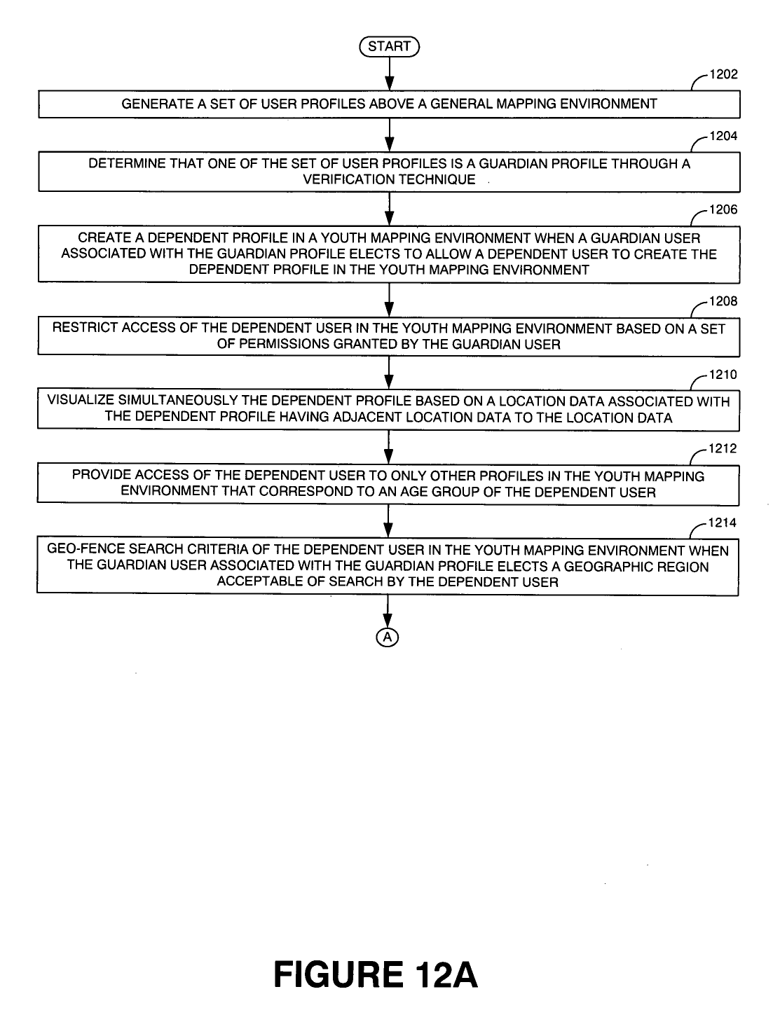

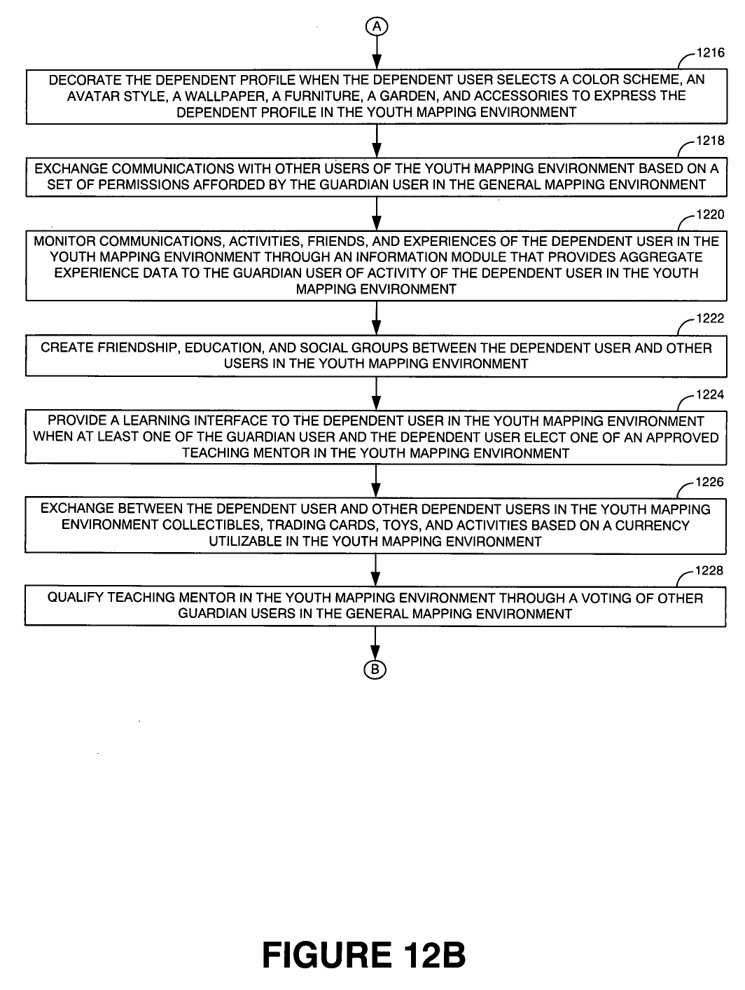

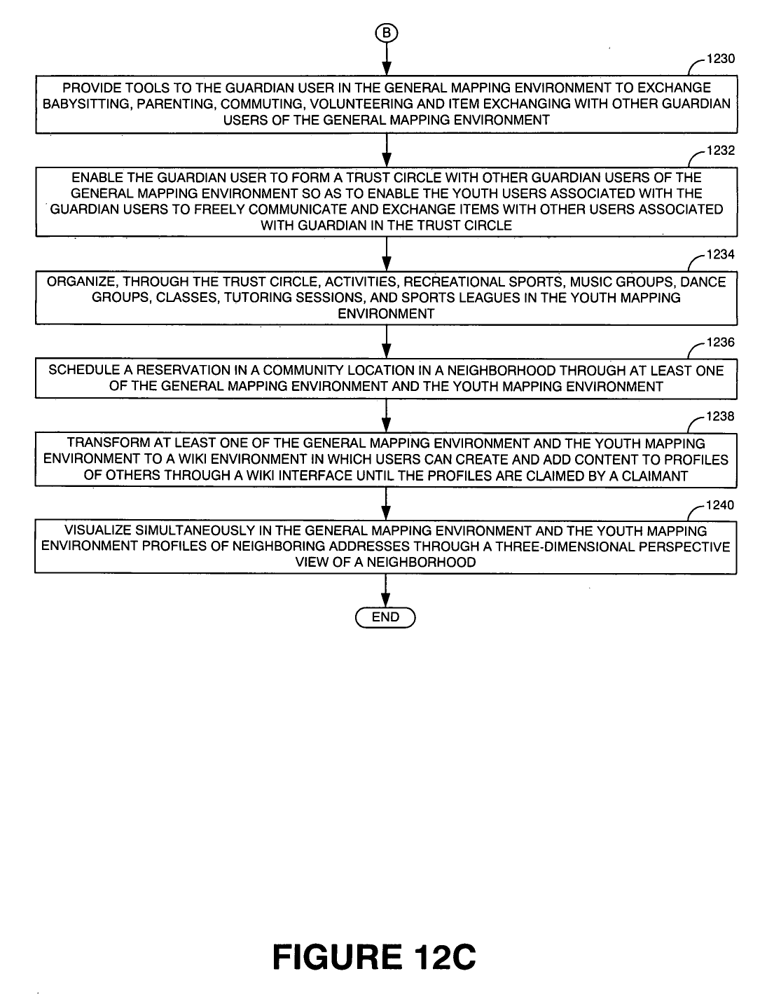

FIG. 12A is a process flow of creating a dependent profile in a youth mapping environment (e.g., the youth mapping environment 128 of FIG. 1), according to one embodiment. In operation 1202, a set of user profiles may be generated above a general mapping environment 130. In operation 1204, it may be determined that one of the set of user profiles is a guardian profile 106 through a verification technique. In operation 1206, a dependent profile in a youth mapping environment 128 may be created when a guardian user 132 associated with the guardian profile 106 may elect to allow a dependent user 138 to create the dependent profile in the youth mapping environment. In operation 1208, access of the dependent user 138 in the youth mapping environment 128 may be restricted based on a set of permissions granted by the guardian user 132.

In operation 1210, the dependent profile may be visualized simultaneously based on a location data associated with the dependent profile along with adjacent dependent profiles having adjacent location data to the location data. In operation 1212, access of the dependent user 138 may be provided to only other profiles in the youth mapping environment 128 that correspond to an age group of the dependent user 138. In operation 1214, search criteria of the dependent users 138 in the youth mapping environment 128 may be geo-fenced when the guardian user 132 associated with the guardian profile may elect a geographic region acceptable of search by the dependent user 138.

FIG. 12B is a continuation of the process flow of FIG. 12A illustrating additional processes, according to one embodiment. In operation 1216, the dependent profile may be decorated when the dependent user 138 selects a color scheme, an avatar style, wallpaper, furniture, a garden, and/or accessories to express the dependent profile in the youth mapping environment 128.

In operation 1218, communications may be exchanged with other users of the youth mapping environment 128 based on a set of permissions afforded by the guardian user 132 in the general mapping environment 130. In operation 1220, communications, activities, friends, and/or experiences of the dependent user 138 in the youth mapping environment 128 may be monitored through an information module 120 that provides aggregate experience data to the guardian user of activity of the dependent user 138 in the youth mapping environment 128.

In operation 1222, friendship, education, and/or social groups may be created between the dependent user and other dependent users 138 in the youth mapping environment 128. In operation 1224, a learning interface may be provided to the dependent user 138 in the youth mapping environment 128 when the guardian user 132 and/or the dependent user 138 elect an approved teaching mentor in the youth mapping environment 128. In operation 1226, collectibles, trading cards, toys, and activities may be exchanged between the dependent user and other dependent users 138 in the youth mapping environment 128 based on a currency utilizable in the youth mapping environment 128. In operation 1228, teaching mentors in the youth mapping environment 128 may be qualified through a voting of other guardian users 132 in the general mapping environment 130.

FIG. 12C is a continuation of the process flow of FIG. 12B illustrating additional processes, according to one embodiment. In operation 1230, tools may be provided to the guardian user 132 in the general mapping environment 130 to exchange babysitting, parenting, commuting, volunteering and item exchanging opportunities with other guardian users of the general mapping environment 130. In operation 1232, the guardian user 132 may be enabled to form a trust circle with other guardian users 132 of the general mapping environment 130 so as to enable the youth users associated with the guardian users 132 to freely communicate and/or exchange items with other users associated with guardians in the trust circle. In operation 1234, activities, recreational sports, music groups, dance groups, classes, tutoring sessions, and sports leagues in the youth mapping environment 128 may be organized through the trust circle,

In operation 1236, a reservation may be scheduled in a community location in a neighborhood through the general mapping environment 130 and the youth mapping environment 128. In operation 1238, the general mapping environment 130 and/or the youth mapping environment 128 may be transformed to a wiki environment in which users may create and/or add content to profiles of others through a wiki interface until the profiles may be claimed by a claimant. In operation 1240, profiles of neighboring addresses in the general mapping environment 130 and the youth mapping environment 128 may be simultaneously visualized through a three-dimensional perspective view of a neighborhood.

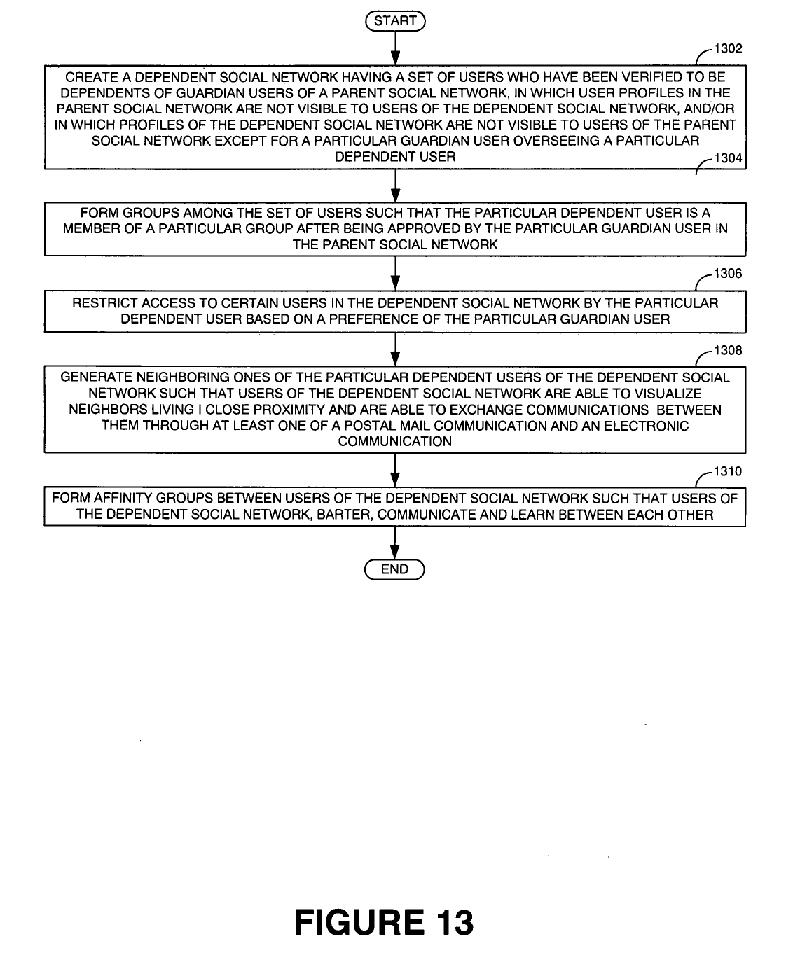

FIG. 13 is a process flow of restricting access to certain users in a dependent social network, according to one embodiment. In operation 1302, a dependent social network having a set of users who have been verified to be dependents of guardian users 132 of a parent social network user may be created, in which user profiles in the parent social network are not visible to users of the dependent social network, and/or in which profile of the dependent social network are not visible to users of the parent social network except for a particular guardian user 132 overseeing a particular dependent 138. In operation 1304, groups among the set of users may be formed such that the particular dependent user 138 may be a member of a particular group after being approved by the particular guardian user 132 in the parent social network.

In operation 1306, access may be restricted to certain users in the dependent social network by the particular dependent user 138 based on a preference of the particular guardian user 132. In operation 1308, neighboring ones of the particular dependent users 138 of the dependent social network may be generated such that users of the dependent social network are able to visualize neighbors living in close proximity and are able to exchange communications between them through postal mail and/or electronic communication. In operation 1310, affinity groups may be formed between users of the dependent social network such that users of the dependent social network barter, communicate and/or learn amongst each other.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry). For example, the central module 100, the profile module 102, the authentication module 108, the security module 110, the privacy module 112, the group module 114, the search module 116, the segregation module 118, the information module 120, the activity module 122, the mapping module 126, the entertainment module 202, the educational activity module 204, the recreational activity module 206, the service module 208, the contact/networking module 210, the create module 302, the edit module 304, the analyze module 306, the update module 308, the review module 310 and the communication module 312 of FIGS. 1-3 may be embodied through a central circuit, a profile circuit, an authentication circuit, a security circuit, a privacy circuit, a group circuit, a search circuit, a segregation circuit, an information circuit, an activity circuit, a mapping circuit, an entertainment circuit 202, an educational activity circuit, a recreational circuit, a service circuit, a contact/networking circuit, a create circuit, an edit circuit, an analyze circuit, an update circuit, a review circuit and a communication circuit using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method comprising:
generating a set of user profiles above a general mapping environment;
determining that one of the set of user profiles is a guardian profile through a verification technique;
creating a dependent profile in a youth mapping environment when a guardian user associated with the guardian profile elects to allow a dependent user to create the dependent profile in the youth mapping environment;
restricting access of the dependent user in the youth mapping environment based on a set of permissions granted by the guardian user; and
simultaneously visualizing the dependent profile based on a location data associated with the dependent profile along with adjacent dependent profiles having adjacent location data to the location data.

2. The method of claim 1 wherein the youth mapping environment does not have profiles found in the general mapping environment and is restricted to including profiles of youth.

3. The method of claim 2 wherein the youth are under eighteen-years of age.

4. The method of claim 3 further comprising providing access of the dependent user to only other profiles in the youth mapping environment that correspond to an age group of the dependent user.

5. The method of claim 4 further comprising geo-fencing search criteria of the dependent users in the youth mapping environment when the guardian user associated with the guardian profile elects a geographic region acceptable of search by the dependent user.

6. The method of claim 1 further comprising decorating the dependent profile when the dependent user selects a color scheme, an avatar style, a wallpaper, a furniture, a garden, and accessories to express the dependent profile in the youth mapping environment.

7. The method of claim 6 further comprising exchanging communications with other users of the youth mapping environment based on a set of permissions afforded by the guardian user in the general mapping environment.

8. The method of claim 1 further comprising monitoring communications, activities, friends, and experiences of the dependent user in the youth mapping environment through an information module that provides aggregate experience data to the guardian user of activity of the dependent user in the youth mapping environment.

9. The method of claim 8 comprising creating friendship, education, and social groups between the dependent user and other dependent users in the youth mapping environment.

10. The method of claim 9 further comprising:
providing a learning interface to the dependent user in the youth mapping environment when at least one of the guardian user and the dependent user elect one of an approved teaching mentor in the youth mapping environment;
exchanging between the dependent user and other dependent users in the youth mapping environment collectibles, trading cards, toys, and activities based on a currency utilizable in the youth mapping environment; and
qualifying teaching mentors in the youth mapping environment through a voting of other guardian users in the general mapping environment.

11. The method of claim 1 further comprising providing tools to the guardian user in the general mapping environment to exchange babysitting, parenting, commuting, volunteering and item exchanging opportunities with other guardian users of the general mapping environment.

12. The method of claim 11 further comprising enabling the guardian user to form a trust circle with other guardian users of the general mapping environment so as to enable the youth users associated with the guardian users to freely communicate and exchange items with other users associated with guardians in the trust circle.

13. The method of claim 12 further comprising
organizing, through the trust circle, activities, recreational sports, music groups, dance groups, classes, tutoring sessions, and sports leagues in the youth mapping environment; and
scheduling a reservation in a community location in a neighborhood through at least one of the general mapping environment and the youth mapping environment.

14. The method of claim 1 further comprising:
transforming at least one of the general mapping environment and the youth mapping environment to a wiki environment in which users can create and add content to profiles of others through a wiki interface until the profiles are claimed by a claimant; and
simultaneously visualizing in the general mapping environment and the youth mapping environment profiles of neighboring addresses through a three-dimensional perspective view of a neighborhood.

15. The method of claim 1 in a form of a machine-readable medium embodying a set of instructions that, when executed by a machine, causes the machine to perform the method of claim 1

16. A system, comprising:
a network;
a youth mapping environment to generate profiles of minors in a neighborhood and to include only minors who have been verified as permitted as participants in the youth mapping environment;
a general mapping environment coupled to the youth mapping environment to enable parents to create access privileges of their minor children in the youth mapping environment; and
a central module to enable the parents to form sharing groups with other parents in the general mapping environment, and to provide an interface such that the parents can monitor activities of their children in the youth mapping environment and to segregate users of the youth mapping environment from users of the general mapping environment.

17. The system of claim 16 further comprising a security module of the central module to ensure that identity of the parents is verified prior to the parents creating access privileges of their minor children in the youth mapping environment.

18. The system of claim 16 further comprising an activity module of the central module to arrange and reserve parks, halls, and restaurants for sharing groups in the general mapping environment and to automatically send invites to dependent users in the youth mapping environment when an arranged activity involves scheduling of children's recreational, educational, and social activities.

19. A method comprising:
creating a dependent social network having a set of users who have been verified to be dependents of guardian users of a parent social network, and in which user profiles in the parent social network are not visible to users of the dependent social network, and in which profile of the dependent social network are not visible to users of the parent social network except for a particular guardian user overseeing a particular dependent user;
forming groups among the set of users such that the particular dependent user is a member of a particular group after being approved by the particular guardian user in the parent social network;
restricting access to certain users in the dependent social network by the particular dependent user based on a preference of the particular guardian user; and
generating neighboring ones of the particular dependent users of the dependent social network such that users of the dependent social network are able to visualize neighbors living in close proximity and are able to exchange communications between them through at least one of a postal mail communication and an electronic communication.

20. The method of claim 19 further comprising forming affinity groups between users of the dependent social network such that users of the dependent social network, barter, communicate and learn between each other.
